(19) United States
(12) Patent Application Publication
(10) Pub. No.: US 2004/0028393 A1
(43) Pub. Date: Feb. 12, 2004

(54) Defect management apparatus and defect management method for rewritable recording medium

(75) Inventor: Keiji Katata, Saitama-ken (JP)

Correspondence Address: SUGHRUE MION, PLLC, 2100 PENNSYLVANIA AVENUE, N.W., WASHINGTON, DC, 20037, US

(73) Assignee: PIONEER CORPORATION

(21) Appl. No.: 10/603,623

(22) Filed: Jun. 26, 2003

(30) Foreign Application Priority Data
Jun. 26, 2002 (JP) 2002-185879

(51) Int. Cl. H04N 5/781

(52) U.S. Cl. 386/113; 386/125

(57) ABSTRACT

A disk drive 121 generates defect information indicating a position of a defect on a recording surface of a DVD-RAM 130 when data recorded on the DVD-RAM is read during the data rewriting against the DVD-RAM. The disk drive determines whether or not the data is recorded at the position of the defect when the data is recorded onto the DVD-RAM and sends the result to a main controller 111. The main controller 111 controls the disk drive such that data including the same contents as those of the data recorded at the position of the defect into a spare area on the DVD-RAM, on the basis of the result of the determination. Recording into the spare area is executed, for example, when the continuous recording of the data into the data area on the DVD-RAM is completed.

### BACKGROUND OF THE INVENTION

1. Field of the Invention

The present invention relates to a defect management apparatus and method for recognizing and managing a defect on a recording surface of a rewritable recording medium for improvement of reliability of data recording for the rewritable recording medium.

2. Description of the Related Art

Rewritable recording media such as magneto-optical disks (MO disks etc.), phase change disks (DVD-RAM etc.), hard disks and the like may involve a defect on their recording surfaces. The defect may be an initial failure existing from the time of shipment of recording media form factories, a flaw or blemish arisen during the storage or usage of recording media, or deterioration caused by the usage of recording media.

The existence of the defect on a recording surface of a recording medium during the data recording by a disk drive or the like against the recording medium may cause a failure in the secure data recording against the recording medium. In view of this, in the art of the rewritable recording media, a technique of detecting a defect existing on a recording surface of a recording medium by a disk drive and recording the data at a position different from the position of the defect has been employed. Such a technique is generally referred to as a “defect management”.

Specifically, once the disk drive received an instruction to record the data into a data area on the recording surface of the recording medium from the host processor (e.g. a main controller of a DVD recorder), the disk drive first records the data into a specified sector in the data area. Next, the disk drive reads the just recorded data from the sector and determines whether the data has been properly recorded. If it is determined that the data has not been properly recorded, it is estimated that the sector is in the defective condition due to the defect on the recording surface. In this case, the disk drive records the data including the same contents of those of the just recorded data into a spare area on the recording surface of the recording medium. That is, the spare area is disposed on the recording surface of the recording medium at a location different from the data area, which is for the normal recording of the data. In the case of the failure to properly record the data into a certain sector in the data area due to the defect on the recording surface, the data is also recorded into the spare area. Thereby, even in the case of the failure to record the data into the sector in the data area due to the defect, the data missing is avoided.

If the data is not properly recorded due to the defect on the recording surface and the data to be recorded into the data area is also recorded into the spare area, the movement of a pickup or head in the disk drive from the data area to the spare area (i.e. seek movement) is involved. For example, in a recording disk such as a DVD-RAM, since the spare area is disposed at the inner circumference of the disk and the data area is disposed at the outer circumference of the disk and outward of the spare area, a long distance for moving the pickup from the data area to the spare area may require a long seek time.

On the other hand, a series of operation: recording the data into the data area; reading the just recorded data; determining whether the data has been properly recorded; alternatively recording the data into the spare area in the case of the failure in the normal recording (hereinafter this series of operation is referred to as a “conventional defect management”) may be executed at every time, for example, when the disk drive records the data into one sector in the data area. Therefore, the seek movement required from the existence of the defect on the recording surface interrupts the data recording, resulting in sacrificing the temporal continuity of the data recording. As a result, the difficulty arises in the data recording against the recording medium for the data, such as video or audio data, involving a continuous recording or a real time recording.

Additionally, if there is the defect on the recording surface, the data is recorded into the spare area disposed at a location different from the data area, which causes the spatial discreteness of the recorded data. Thereby, even the data involving the continuity such as video or audio data is discretely recorded. As a result, the seek movement during the reproduction of the data recorded in the recording medium causes a problem of failure to continuously reproduce the video or audio data.

On the other hand, to record the data involving the continuity such as video or audio data, the data recording without the defect management is possible under the condition that the defect management is set free not to be executed during the data recording. In this way, the seek movement is not caused even if the defect exists on the recording surface, resulting in the allowance of the continuous recording of the video or audio data. In this case, however, the data recorded in the data area may dropout due to the defect on the recording surface, if exists. This dropout or missing of the data may cause a serious problem or damage depending on the kind or contents of the dropout or missing data. For example, in the case of video data, if the dropout or missing data is picture data itself, the dropout or missing may cause a slight damage ending in the noise in the picture. On the other hand, the dropout or missing data is the control or management data, the dropout or missing may cause a serious damage ending in the failure to reproduce the picture. Therefore, the defect management is required to securely record the data at least for the control or management data. Thus, setting the defect management free for all the data is not preferable.

Additionally, the conventional defect management is typically executed independently by the disk drive with a controller disposed therein. That is, for example in a DVD recorder, the disk drive is connected to a main controller for the central control of the DVD recorder. For instance, if an instruction to record the data into the DVD-RAM is inputted from an external device to the DVD recorder, the main controller of the DVD recorder sends to the disk drive only the recording command and the data to be recorded, the conventional defect management is controlled under the self-control of the disk drive independently and asynchronously against the control under the main controller of the DVD recorder. Thereby, the main controller of the DVD recorder cannot predict the seek movement caused by the detection of the defect on the recording surface of the DVD-RAM and involving the interruption of the data recording inside of the disk drive. As a result, it appears difficult to provide a control mechanism to execute the continuous data recording for the data such as video or audio data involving the continuity to the main controller of the DVD recorder.

### SUMMARY OF THE INVENTION

It is therefore an object of the present invention to provide a defect management apparatus and method for a rewritable recording medium wherein the defect management can be executed without sacrificing the continuity required for the continuous or real-time data recording/reproduction.

The above object of the present invention can be achieved by a defect management apparatus for performing a defect management for a rewritable recording medium having a data area and a spare area in its recording surface, the defect management apparatus comprising: a defect information generating device for generating defect information which indicates at least a position of a defect existing in the recording surface of the rewritable recording medium, when data recorded in the recording surface of the rewritable recording medium is read; a recording position determining device for determining, on the basis of the defect information, whether or not the data is recorded at the position of the defect, when the data is recorded into the rewritable recording medium; an alternative recording device for executing an alternative recording for recording data including the same contents as those of the data recorded at the position of the defect into the spare area of the rewritable recording medium, if the recording position determining device determines that the data is recorded at the position of the defect; and a time controlling device for controlling a time point to execute the alternative recording by the alternative recording device such that the alternative recording is executed within a time period that continuation of a state that recording the data into the rewritable recording medium is not performed is predicted.

The above object of the present invention can be achieved by a data recording apparatus for recording data into a rewritable recording medium having a data area and a spare area in its recording surface while performing a data communication with a recording control apparatus, the data recording apparatus comprising: a defect information generating device for generating defect information which indicates at least a position of a defect existing on or in the recording surface of the rewritable recording medium, when the data recorded in the recording surface of the rewritable recording medium is read; a recording position determining device for determining, on the basis of the defect information, whether or not the data is recorded at the position of the defect, when the data is recorded into the rewritable recording medium; a sending device for sending notice that the data is recorded at the position of the defect to the recording control apparatus, if the recording position determining device determines that the data is recorded at the position of the defect; and an alternative recording device for executing an alternative recording for recording data including the same contents as those of the data recorded at the position of the defect into the spare area of the rewritable recording medium, if an instruction to execute the alternative recording is received from the recording control apparatus.

The above object of the present invention can be achieved by a recording control apparatus for controlling a data recording apparatus for recording data into a rewritable recording medium having a data area and a spare area in its recording surface, while performing a data communication with the data recording apparatus, the recording control apparatus comprising: a recognizing device for recognizing that the data recording apparatus records the data at a position of a defect existing on a recording surface of the rewritable recording medium; an instructing device for sending, to the data recording apparatus, an instruction to execute an alternative recording for recording data including the same contents as those of the data recorded at the position of the defect into the spare area of the rewritable recording medium, if the recognizing device recognizes that the data recording apparatus records the data at the position of the defect; and a time controlling device for controlling a time point to send the instruction to execute the alternative recording via the instructing device such that the instruction is sent within a time period that continuation of a state that recording the data into the rewritable recording medium is not performed is predicted.

The above object of the present invention can be achieved by a defect management apparatus for performing a defect management for a rewritable recording medium, the defect management apparatus comprising: a defect information generating device for generating defect information which indicates at least a position of a defect existing on or in a recording surface of the rewritable recording medium, when data recorded in the recording surface of the rewritable recording medium is read; a recording position determining device for determining, on the basis of the defect information, a recording position which is located at a position different from the position of the defect; and a recording device for recording the data at the recording position determined by the recording position determining device.

The above object of the present invention can be achieved by a defect management method of performing a defect management for a rewritable recording medium having a data area and a spare area in its recording surface, the defect management method comprising: a defect information generating process of generating defect information which indicates at least a position of a defect existing on or in the recording surface of the rewritable recording medium, when data recorded in the recording surface of the rewritable recording medium is read; a recording position determining process of determining, on the basis of the defect information, whether or not the data is recorded at the position of the defect, when the data is recorded into the rewritable recording medium; and an alternative recording process of executing an alternative recording for recording data including the same contents as those of the data recorded at the position of the defect into the spare area of the rewritable recording medium, if a fact that the data is recorded at the position of the defect is determined in the recording position determining process, wherein a time point to execute the alternative recording is controlled such that the alternative recording is executed within a time period that continuation of a state that recording the data into the rewritable recording medium is not performed is predicted.

The above object of the present invention can be achieved by a defect management method of performing a defect management for a rewritable recording medium, the defect management method comprising: a defect information generating process of generating defect information which indicates at least a position of a defect existing on or in a recording surface of the rewritable recording medium, when data recorded in the recording surface of the rewritable recording medium is read; a recording position determining process of determining, on the basis of the defect information, a recording position which is located at a position different from the position of the defect; and a recording process of recording the data at the recording position determined by the recording position determining device.

The nature, utility, and further features of this invention will be more clearly apparent from the following detailed description with reference to preferred embodiments of the invention when read in conjunction with the accompanying drawings briefly described below.

### BRIEF DESCRIPTION OF THE DRAWINGS

FIG. 1 is a block diagram illustrating the structure of a defect management apparatus according to a first embodiment.

FIG. 2 is a flow chart illustrating the operation of the defect management apparatus according to the first embodiment.

FIG. 3 is a flow chart illustrating the first aspect in the structure and the operation of an alternative recording device in the defect management apparatus according to the first embodiment.

FIG. 4 is a flow chart illustrating the second aspect in the structure and the operation of the alternative recording device in the defect management apparatus according to the first embodiment.

FIG. 5 is a block diagram illustrating the structure of a defect management apparatus according to a second embodiment.

FIG. 6 is a flow chart illustrating the operation of the defect management apparatus according to the second embodiment.

FIG. 7 is a flow chart illustrating an aspect in the structure and the operation of an alternative recording device in the data recording apparatus in the defect management apparatus according to the second embodiment.

FIG. 8 is a block diagram illustrating the structure of a defect management apparatus according to a third embodiment.

FIG. 9 is a flow chart illustrating the operation of the defect management apparatus according to the third embodiment.

FIG. 10 is a block diagram illustrating the structure of a DVD recorder according to a first example.

FIG. 11 is a conceptual diagram illustrating the structure of a recording surface of a DVD-RAM.

FIG. 12 is a flow chart illustrating a main routine of the defect management.

FIG. 13 is a flow chart illustrating the reading operation.

FIG. 14 is a flow chart illustrating the normal recording operation.

FIG. 15 is a flow chart illustrating the operation of the alternative recording according to the first example.

FIG. 16 is a flow chart illustrating the structure and the operation of the defect management performed by a DVD recorder according to a second example.

FIG. 17 is a block diagram illustrating the structure of a DVD recorder according to a third example.

FIG. 18 is a flow chart illustrating a main routine of the defect management.

FIG. 19 is a flow chart illustrating the operation of the alternative recording according to the third example.

### DETAILED DESCRIPTION OF THE PREFERRED EMBODIMENTS

The preferred embodiments of the present invention will now be discussed, referring to drawings.

(First Embodiment)

The first embodiment of the invention will now be discussed.

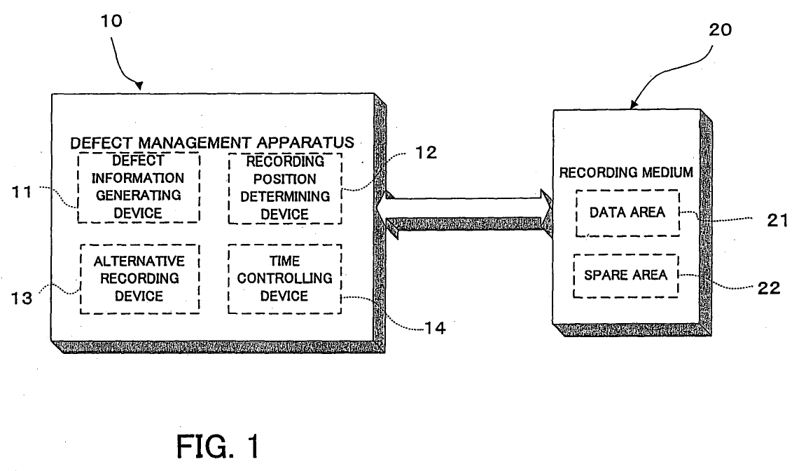

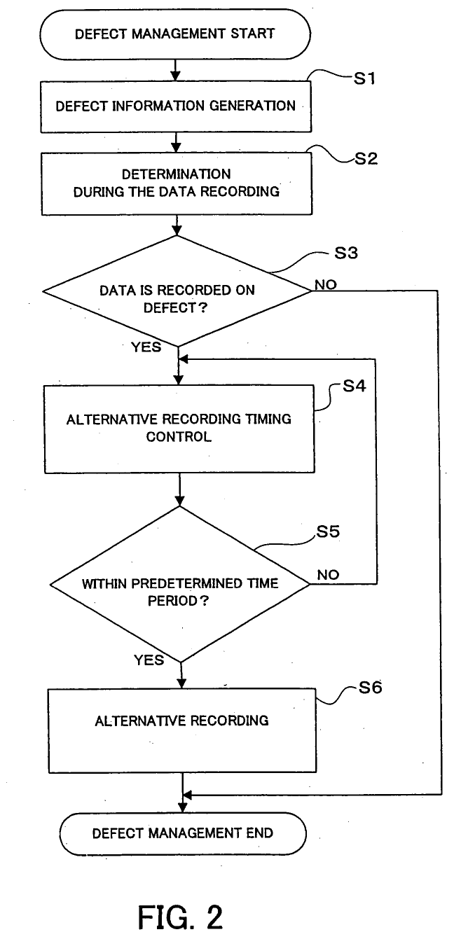

FIG. 1 is a block diagram illustrating the structure of a defect management apparatus according to the first embodiment. FIG. 2 is a flow chart illustrating the operation of the defect management apparatus according to the first embodiment.

In FIG. 1, a defect management apparatus 10 is an apparatus for performing a defect management for a rewritable recording medium 20 having a data area 21 and a spare area 22 in its recording surface. The defect management apparatus 10 is provided with a defect information generating device 11, a recording position determining device 12, an alternative recording device 13 and a time controlling device 14.

The defect information generating device 11 is a device for generating defect information which indicates at least a position of a defect existing on or in the recording surface of the rewritable recording medium 20, when data recorded in the recording surface of the rewritable recording medium 20 is read.

The recording position determining device 12 is a device for determining, on the basis of the defect information, whether or not the data is recorded at the position of the defect (may referred to as “D/P”), when the data into the rewritable recording medium 20 is recorded.

The alternative recording device 13 is a device for executing an alternative recording (sparing) for recording data including the same contents as those of the data recorded at the position of the defect into the spare area 22 of the rewritable recording medium 20, if the recording position determining device 12 determines that the data is recorded at the position of the defect.

The time controlling device 14 is a device for controlling a time point to execute the alternative recording by the alternative recording device such that the alternative recording is executed within a time period that continuation of a state that recording the data into the rewritable recording medium is not performed is predicted.

The defect management apparatus. 10 constructed in such a way performs a defect management as shown in FIG. 2, when the data recorded on the recording surface of the recording medium 20 is rewritten. Namely, to rewrite the data recorded on the recording medium 20, the data recorded on the recording medium 20 is read first. At this time, a defect information generating device 11 generates defect information (step S1). The defect information includes information at least indicating the position of the defect on the recording surface of the recording medium.

To rewrite the data recorded on the recording medium 20, new data is then recorded on the recording medium 20. At this time, the data is recorded, regardless whether a defect exists or not on the recording surface of the recording medium 20. Namely, even if a defect exists on the recording medium, the data is also recorded at the position of the defect on the recording medium. In this context, the “defect” may be an initial failure from the shipment of the recording medium from a factory, a defect such as a flaw or blemish, otherwise a defect caused by deterioration over long usage of the recording medium. Nevertheless, the defect herein is not intended to mean a defect incapable of recording at all. The “defect” herein may be a portion where the rewritable number of times (rewritable life) is fewer (shorter) than that of a portion without defect, or a portion where the reliability or stability of the data is inferior. Therefore, data can be recorded also at the position of defect on the recording medium, even with low reliability of the recorded data.

When new data is recorded on the recording medium 20, the recording position determining device 12 then determines whether or not the data is recorded at the position of the defect, on the basis of the defect information (step S2 and S3).

Next, if the recording position determining device 12 determines that the data is recorded at the position of the defect, an alternative recording device 13 attempts to execute an alternative recording. At this time, a time controlling device 14 controls a time point to execute the alternative recording such that the alternative recording is executed within a time period that continuation of a state that recording the data into the rewritable recording medium is not performed is predicted (step S4 and S5). Namely, at the time when the continuation of the state that recording the data into the rewritable recording medium is not performed is predicted, the time controlling device 14 allows to execute the alternative recording.

The alternative recording device 13 performs the alternative recording after receiving the allowance from the time controlling device 14. Namely, the alternative recording device 13 records data, which includes the same contents as those of the data recorded at the position of the defect on the recording medium 20, into the spare area 22 of the recording medium 20 (step S6). In this way, the data, which includes the same contents as those of the data recorded with low reliability at the position of the defect, is recorded into the spare area. Therefore, the data can be stored in the spare area with normal recording condition of high reliability.

Thus, according to the defect management apparatus 10, reading/recording of the data from/into the recording medium 20 is executed prior to the alternative recording, which is in turn executed within the time period that continuation of the state that recording the data into the rewritable recording medium is not performed is predicted. Thereby, the data recording into the recording medium 20 can be executed in a temporally continuous manner. Therefore, data involving the continuous recording or the real time recording, such as video or audio data, can be recorded in a temporally continuous manner. Further, since the alternative recording is executed within the time period that continuation of the state that recording the data into the rewritable recording medium is not performed is predicted, the data missing due to the defect on the recording medium can be prevented.

(Various Aspects in the First Embodiment)

Various aspects in the first embodiment will now be discussed.

An alternative recording device provided with a recognizing device, a reading device and a recording device may be used as the alternative recording device 13 in the defect management apparatus 10. This type of alternative recording device is referred to as a “first alternative recording device”.

In the first alternative recording device, the recognizing device is a device for recognizing the position of the defect on the basis of the defect information. The reading device is a device for reading the data recorded at the position of the defect recognized by the recognizing device. The recording device is a device for recording the data read by the reading device into the spare area 22 of the rewritable recording medium 20.

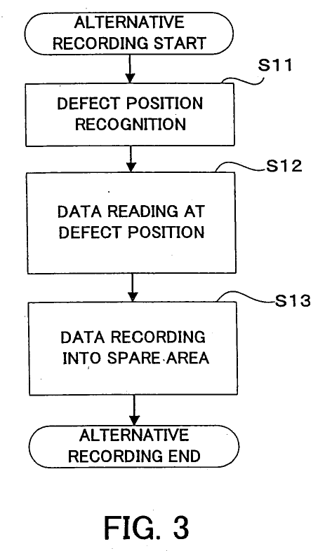

In the first alternative recording device, an shown in FIG. 3, when the time controlling device 14 allows the recognizing device to execute the alternative recording, the recognizing device recognizes the position of the defect on the recording surface of the recording medium 20, on the basis of the defect information generated by the defect information generating device 11 (step S11).

Next, the reading device reads the data, which is recorded at the position of the defect and recognized by the recognizing device, from the recording medium 20 (step S12).

Then, the recording device records the data read by the reading device into the spare area on the recording medium 20 (step S13).

According to the first alternative recording device, the alternative recording allows that the data recorded at the position of the defect on the recording surface of the recording medium 20 is read and then recorded into the spare area 22. Therefore, it is possible to easily and effectively obtain data including the same contents of those of the data recorded at the position of the defect on the recording medium 20. As a result, it is not necessary that the data to be recorded into the spare area 22 is stored in the storing device such as a buffer memory when the data is recorded into the data area. This is advantageous if the data to be recorded in the recording medium 20 is temporary data or a great volume of data, such as video data supplied digital broadcasting.

Alternatively, an alternative recording device provided with a recognizing device, an alternative-recording determining device, a reading device and a recording device may be used as the alternative recording device 13 in the defect management apparatus 10. This type of alternative recording device is referred to as a “second alternative recording device”.

In the second alternative recording device, the recognizing device is a device for recognizing the position of the defect on the basis of the defect information. The alternative-recording determining device is a device for determining whether or not the data recorded at the position of the defect is data that requires the alternative recording. The reading device is a device for reading the data recorded at the position of the defect recognized by the recognizing device, if the alternative-recording determining device determines that the data recorded at the position of the defect is the data that requires the alternative recording. The recording device is a device for recording the data read by the reading device into the spare area 22 of the rewritable recording medium 20.

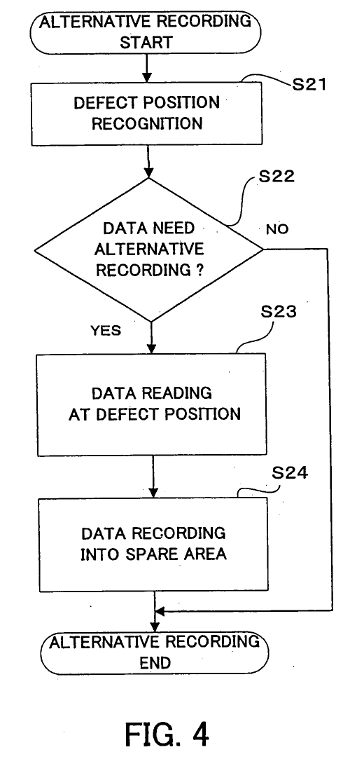

In the second alternative recording device, an shown in FIG. 4, when the time controlling device 14 allows the recognizing device to execute the alternative recording, the recognizing device recognizes the position of the defect on the recording surface of the recording medium 20, on the basis of the defect information generated by the defect information generating device 11 (step S21).

Next, the alternative-recording determining device determines whether or not the data recorded at the position of the defect is data that requires the alternative recording (step S22). The basis for determining whether or not the data is to be alternatively recorded may be chosen as appropriate. Specifically, it may be the importance or the kind of the data. For instance, only the control or management data may be determined as the data that the alternative recording is required.

Then, if the alternative-recording determining device determined that the data recorded at the position of the defect is the data that requires the alternative recording, the reading device reads the data, which is recorded at the position of the defect and recognized by the recognizing device, from the recording medium 20 (step S23). Next, the recording device records the data read by the reading device into the spare area 22 on the recording medium 20 (step S24).

According to the second alternative recording device, in the alternative recording, the data recorded at the position of the defect on the recording medium 20 is checked, and then the data is determined whether or not the alternative recording is required, and only the data that the alternative recording is required is recorded into the spare area 22 on the recording medium 20. For instance, data impermissible of dropout or missing is recorded in the spare area 22, while data having priority in the continuity of the recording is not recorded in the spare area 22. Thereby, the data impermissible of dropout or missing can be recorded, and, the data having priority in the continuity of the recording can be recorded in the data area 21 of the recording medium continuously in place.

For instance, in the case that video data made of control data, management data, picture data or the like is recorded in the recording medium 20, the control data and the management data can be securely recorded into the recording medium 20, while the picture data can be continuously recorded into the recording medium 20, by setting only the control or management data as the data that the alternative recording is required. As a result, when the video data recorded in the recording medium 20 is reproduced, the control or management data can be securely reproduced, while the picture data can be continuously reproduced.

Referring again to FIG. 1, the embodiment of the time controlling device 14 will be discussed. In FIG. 1, as discussed above, the time controlling device 14 controls a time point to execute the alternative recording by the alternative recording device 13 such that the alternative recording is executed within a time period that continuation of a state that recording the data into the recording medium 20 is not performed is predicted (step S4 and S5). Now, the time period that continuation of the state that recording the data into the recording medium 20 is not performed is predicted may be a time point when an instruction to stop or suspend the data recording is inputted. Alternatively, the time period that continuation of the state that recording the data into the recording medium 20 is not performed is predicted may be a time point when the recording of the video or audio data to be recorded continuously is completed.

Further, the first embodiment or various aspects thereof as discussed above may be embodied in a structure integrated with hardware as a special designed device/apparatus or in making a computer read the program.

(Second Embodiment)

The second embodiment of the present invention will now be discussed.

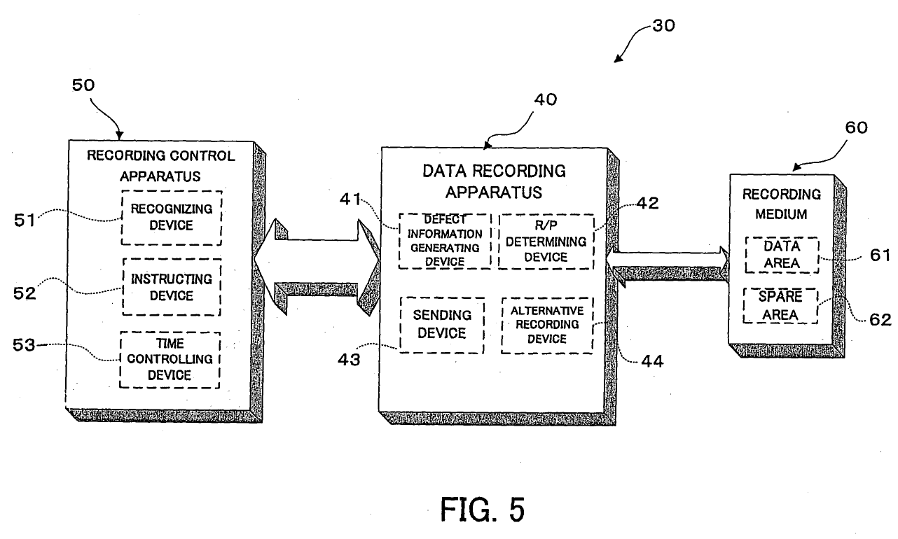

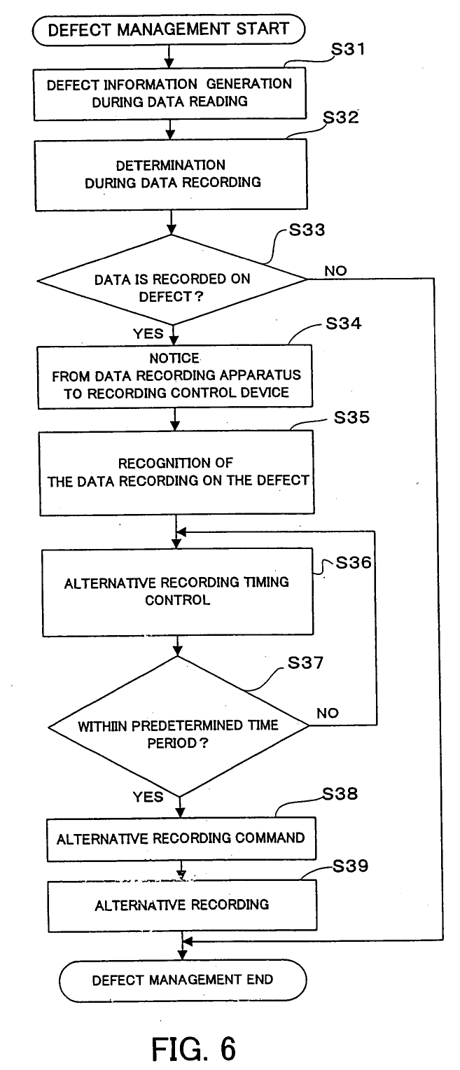

FIG. 5 is a block diagram illustrating the structure of the defect management apparatus according to the second embodiment. FIG. 6 is a flow chart illustrating the operation of the defect management apparatus.

As shown in FIG. 5, the defect management apparatus 30 according to the second embodiment is provided with a data recording apparatus 40 and a recording control apparatus 50.

The data recording apparatus 40 is an apparatus for recording data into a rewritable recording medium 60 having a data area 61 and a spare area 62 in its recording surface while performing a data communication with the recording control apparatus 50. The data recording apparatus 40 is provided with: a defect information generating device 41, a recording position determining device 42, a sending device 43 and an alternative recording device 44.

The defect information generating device 41 is a device for generating defect information which indicates at least a position of a defect existing on or in the recording surface of the rewritable recording medium 60, when the data recorded in the recording surface of the rewritable recording medium 60 is read.

The recording position determining device 42 is a device for determining, on the basis of the defect information, whether or not the data is recorded at the position of the defect, when the data is recorded into the rewritable recording medium 60.

The sending device 43 is a device for sending notice that the data is recorded at the position of the defect to the recording control apparatus 50, if the recording position determining device 42 determines that the data is recorded at the position of the defect.

The alternative recording device 44 is a device for executing an alternative recording (sparing) for recording data including the same contents as those of the data recorded at the position of the defect into the spare area 62 of the rewritable recording medium 60, if received an instruction to execute the alternative recording from the recording control apparatus 50.

The recording control apparatus 50 is an apparatus for controlling a data recording apparatus 40, while performing the data communication with the data recording apparatus 40. The recording control apparatus 50 is provided with: a recognizing device 51, an instructing device 52 and a time controlling device 53.

The recognizing device 51 is a device for recognizing that the data recording apparatus 40 records the data at a position of a defect existing on or in a recording surface of the rewritable recording medium 60.

The instructing device 52 is a device for sending, to the data recording apparatus 40, an instruction to execute an alternative recording for recording data including the same contents as those of the data recorded at the position of the defect into the spare area 62 of the rewritable recording medium 60, if the recognizing device 51 recognizes that the data recording apparatus 40 records the data at the position of the defect.

The time controlling device 53 is a device for controlling a time point to send the instruction to execute the alternative recording via the instructing device such that the instruction is sent within a time period that continuation of a state that recording the data into the rewritable recording medium 60 is not performed is predicted.

The defect management apparatus 30 constructed in such a way performs a defect management when the data recorded on the recording surface of the recording medium 60 is rewritten. Namely, as shown in FIG. 6, the defect information generating device 41 in the data recording apparatus 40 generates the defect information, upon reading of the data recorded on the recording surface of the recording medium 60 (step S31). The defect information includes information at least indicating the position of the defect on the recording surface of the recording medium.

Next, when new data is recorded into the recording medium 60, the recording position determining device 42 in the data recording apparatus 40 determines whether or not the data is recorded at the position of the defect, on the basis of the defect information (step S32 and S33). It is noted that the data recording at this stage is executed regardless of the existence of the defect on the recording surface of the recording medium. That is, even if there is a defect on the recording surface of the recording medium, the data is recorded also at the position of the defect.

If the recording position determining device 42 determined that the data is recorded at the position of the defect, the sending device 43 in the data recording apparatus 40 sends notice that the data is recorded at the position of the defect to the recording control apparatus 50 (step S34).

Next, the recognizing device 51 in the recording control apparatus 50 receives the notice from the data recording apparatus 40 and recognizes that the data is recorded at the position of the defect on the recording surface of the recording medium 60 by the data recording apparatus 40 (step S35).

If the recognizing device 51 recognized that the data recording apparatus 40 recorded the data at the position of the defect on the recording surface of the recording medium 60, it is attempted that the recording control apparatus 50 sends, to the data recording apparatus 40, an instruction to execute an alternative recording for recording data including the same contents as those of the data recorded at the position of the defect on the recording medium 60 into the spare area 62 of the recording medium 60. At this time, the time controlling device 53 in the recording control apparatus 50 controls the time point to send the instruction to execute the alternative recording by the instructing device 52 such that the instruction is sent within a time period that continuation of a state that recording the data into the recording medium 60 is not performed is predicted (step S36 and S37). That is, when continuation of the state that recording the data into the recording medium 60 is not performed is predicted, the time controlling device 53 allows sending the instruction to execute the alternative recording.

The instructing device 52 in the recording control apparatus 50 sends, to the data recording apparatus 40, the instruction to execute the alternative recording, after receiving the allowance from the time controlling device 53 (step S38).

The alternative recording device 44 in the data recording control apparatus 40 receives the instruction to execute the alternative recording sent from the recording control apparatus 50 and executes the alternative recording. That is, the alternative recording device 44 records the data including the same contents of those of the data recorded at the position of the defect on the recording medium 60 into the spare area 62 of the recording medium 60 (step S39).

Thus, according to the defect management apparatus 30, the data reading/recording from/into the recording medium 60 is executed first, and then the alternative recording of the data is executed at the time point when continuation of the state that the data is not recorded on the recording medium 60 is predicted, so that the data can be recorded on the recording medium 60 in a temporally continuous manner. Therefore, data involving the continuous recording or the real time recording, such as video or audio data, can be recorded into the recording medium in a temporally continuous manner. Further, since the alternative recording is executed within the time period that continuation of the state that recording the data into the recording medium is not performed is predicted, the dropout or missing of the data due to the defect on the recording medium can be prevented.

On the other hand, the recording control apparatus 50 receives the defect information from the data recording apparatus 40, and executes the alternative recording, on the basis of the received defect information. Therefore, for instance, in the case that the defect management apparatus 30 according to the present embodiment is applied to the DVD player, the recording control apparatus 50 may be applied to a main controller of a DVD player, and the data recording apparatus 40 may be applied to a disk drive of the DVD player. In this case, a main controller of the DVD player can control all over the defect management. Thereby, the main controller can predict the alternative recording (if necessary) and thereby can freely determine the necessity or the schedule and the like of the alternative recording, taking account of various factors such as the input condition, the kind, the importance of the data to be recorded. Therefore, the data can be recorded into the recording medium 60 at the optimal condition depending on the kind of the data.

(Various Aspects in the Second Embodiment)

Various aspects in the second embodiment will now be discussed.

The alternative recording device provided with a reading device and a recording device may be used as the alternative recording device 44 in the data recording apparatus 40. This type of the alternative recording device is referred to as a “third alternative recording device”.

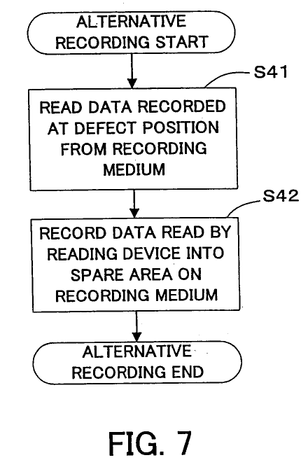

In the alternative recording by the third alternative recording device, as shown in FIG. 7, the reading device reads the data recorded at the position of the defect from the rewritable recording medium 60 (Step S41). The recording device records the data read by the reading device into the spare area 62 of the rewritable recording medium 60 (Step S42).

According to the third alternative recording device, in the alternative recording, since the data recorded at the position of the defect on the recording surface of the recording medium 60 is read and then recorded into the spare area 62, data including the same contents of those of the data recorded at the position of the defect on the recording medium 60 can be obtained easily and effectively. Therefore, it is unnecessary to store the data to be recorded into the spare area 62 in the buffer memory or the like while the data is recorded into the data area. This is advantageous in the case that the data to be recorded into the recording medium 60 is temporary data or a great volume of data, such as video data supplied digital broadcasting.

An instructing device having an alternative-recording determining device may be used as the instructing device 52 in the recording control apparatus 50. The alternative-recording determining device determines whether or not the data recorded at the position of the defect by the data recording apparatus 40 is data that requires the alternative recording.

In the alternative-recording determining device, the basis for determining whether or not the data is data that requires the alternative recording may be chosen as appropriate. For instance, it may be the importance or kind of the data. More specifically, the alternative-recording determining device may determine that the data recorded at the position of the defect is the data that requires the alternative recording, if the data recorded at the position of the defect is the control data or management data.

Thus, since the data recorded at the position of the defect on the recording medium 60 is checked, and then determined whether or not the alterative recording is required, and only the data that the alternative recording is required is recorded into the spare area 62 of the recording medium 60, it is possible that, for instance, data impermissible of dropout or missing is alternatively recorded so that the data is securely recorded into the recording medium, while data having priority in the continuity of the recording is not alternatively recorded so that the data is continuously recorded into the recording medium. Thus, the optimal recording can be provided depending on the nature or kind of the data.

Referring again to FIG. 5, one aspect of the time control device 53 in the recording control apparatus 50 will be discussed. In FIG. 5, as discussed above, the time control device 53 controls a time point to send the instruction to execute the alternative recording by the alternative recording device 52 such that the instruction is sent within a time period that continuation of a state that recording the data into the recording medium is not performed is predicted (step S36 and S37). Herein the time period that continuation of the state that recording the data into the recording medium is not performed is predicted may be a time point that an instruction to stop or suspend the data recording is inputted. Alternatively, the time period that continuation of the state that recording the data into the recording medium is not performed is predicted may be a time point that recording video or audio data to be recorded continuously is complete.

Further, the second embodiment or various aspects thereof as discussed above may be embodied in a structure integrated with hardware as a special designed device/apparatus or in making a computer read the program.

(Third Embodiment)

The third embodiment of the present invention will now be discussed.

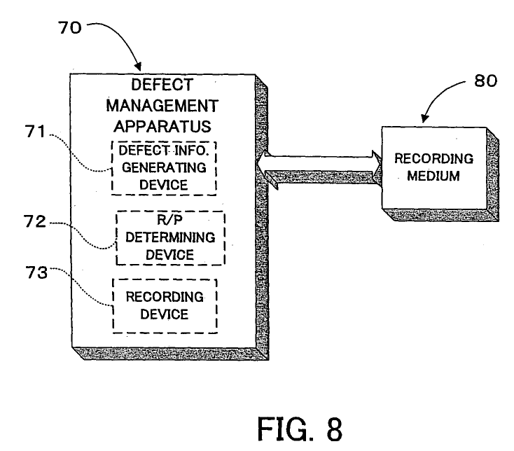

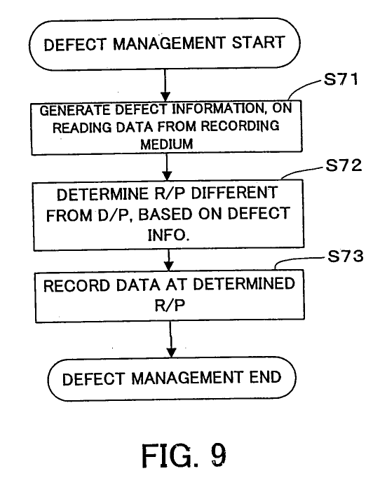

FIG. 8 is a block diagram illustrating the structure of the defect management apparatus according to the third embodiment of the invention. FIG. 9 is a flow chart illustrating the operation of the defect management apparatus according to the third embodiment of the invention.

In FIG. 8, a defect management apparatus 70 is an apparatus for performing a defect management for a rewritable recording medium 80. The defect management apparatus 70 is provided with: a defect information generating device 71, a recording position determining device 72 and a recording device 72.

The defect information generating device 71 is a device for generating defect information which indicates at least a position of a defect existing on or in a recording surface of the rewritable recording medium 80, when data recorded in the recording surface of the rewritable recording medium 80 is read.

The recording position determining device 72 is a device for determining, on the basis of the defect information, a recording position (may referred to as “R/P”) which is located at a position different from the position of the defect.

The recording device 73 is a device for recording the data at the recording position determined by the recording position determining device 72.

The defect management apparatus 70 constructed in such a way performs the defect management when the data recorded on the recording surface of the recording medium 80 is rewritten. That is, as shown in FIG. 9, the defect information generating device 71 generates defect information first, when the data recorded on the recording medium 80 is read (step S71). The defect information includes information which indicates at least the position of the defect existing on or in the recording surface of the recording medium 80.

Next, the recording position determining device 72 determines a recording position which is located at a position different from the position of the defect on the recording surface of the recording medium 80, on the basis of the defect information generated by the defect information generating device 71 (step S72).

Then the recording device 73 records the data onto the recording position determined by the recording position determining device 72 (step S73).

Thereby, before the data recording is actually started, the position of the defect on the recording surface of the recording medium 80 is recognized and the data recording position can be determined such that the recording position is located at a position different from the position of the defect. Therefore, after the data recording is actually started, the data can be recorded simply at the data recording position already determined. Thus, by determining the data recording position not to sacrifice the continuity of the data, the data can be recorded into the recording medium 80 continuously at the recording position, and since the recording at the position of the defect on the recording medium can be avoided, the data missing or dropout due to the defect on the recording medium can be avoided.

(Various Aspects in the Third Embodiment)

In the defect management apparatus 70 according to the third embodiment, the recording position determining device 72 may be constructed such that the recording position is determined to avoid the position of the defect on the recording surface of the recording medium 80, only when the data to be recorded is the control or management data.

Further, the third embodiment or various aspects thereof as discussed above may be embodied in a structure integrated with hardware as a special designed device/apparatus or in making a computer read the program.

### EXAMPLES

Examples of the present invention will now be discussed, referring to drawings. In examples below, the present invention is applied to a DVD recorder for rewriting the data against a DVD-RAM, which is a rotating rewritable recording medium.

### First Example

The first example of the invention will now be discussed.

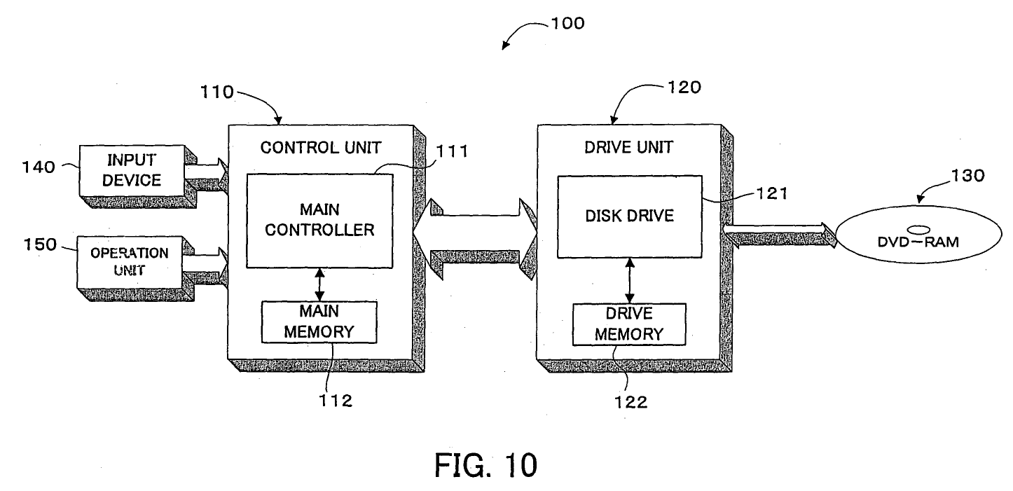

FIG. 10 is a block diagram illustrating the structure of a DVD recorder according to the first example. In FIG. 10, the DVD recorder 100 is a recorder having a function of rewriting the data against a DVD-RAM. The DVD recorder 100 is provided with a control unit 110, a drive unit 120, an input device 140 and an operation unit 150.

The control unit 110 includes a main controller 111 and a main memory 112. The main controller 111 has a CPU (Central Processing Unit) and other processing circuits for controlling all over the DVD recorder 100 including controlling the drive unit 120.

The main memory 112 is a rewritable storage circuit such as RAM (random access memory). The main memory 112 is connected to the main controller 111 for storing the data or information necessary for the operation of the main controller 111.

The drive unit 120 includes a disk drive 121 and a drive memory 122. The disk drive 121 has a disk mount for loading a DVD-RAM 130, a spindle servo mechanism and a spindle motor for rotating the DVD-RAM 130, an optical pickup for reading/recording the data from/into the DVD-RAM 130, a tracking servo/focus servo mechanism for controlling the light spot of the optical pickup. The disk drive 121 further has an processing circuit such as CPU for generating the defect information or detecting error(s) of the data recorded on the DVD-RAM 130, as discussed below. Further, the disk drive 121 is connected to the main controller 111 for the two-way communication with the main controller 111.

The drive memory 122 is a rewritable storage circuit such as RAM. The drive memory 122 is connected to the disk drive 121 for storing the data or information necessary for the operation of the disk drive 121.

The input device 140 is an input circuit for taking into the DVD recorder 100 video data or the like, which may be supplied via digital broadcasting, and connected to the main controller 111.

The operation unit 150 is a user interface for a user operation against the DVD recorder 100, and includes various switches for a user input command such as start command, stop command or pause command of the recording, or eject command of the DVD-RAM 130. The operation unit 150 is connected to the main controller 111.

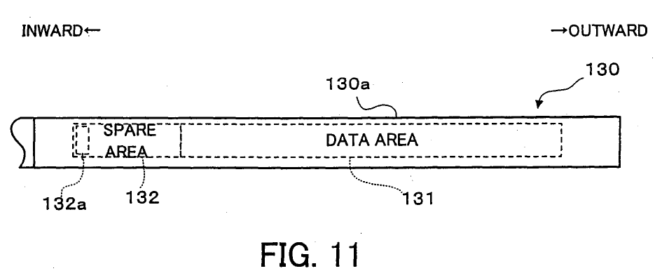

FIG. 11 is a schematic diagram illustrating the structure of the recording surface 130a of the DVD-RAM 130. In FIG. 11, a left to right (or right to left) direction in the figure corresponds to the radial direction of the DVD-RAM 130, and left side in the figure corresponds to the inner side of the DVD-RAM 130 and right side in the figure corresponds to the outer side of the DVD-RAM 130. As shown in FIG. 11, a data area 131 and a spare area 132 are disposed on the recording surface 130a of the DVD-RAM 130. The data area 131 is disposed at outer side on the DVD-RAM 130 compared to the spare area 132. The spare area 132 is disposed at inner side on the DVD-RAM 130 compared to the data area 132. Additionally, a spare table 132a is disposed at the inner periphery of the spare area 132.

The data area 131 is an area in which the data to be recorded into the DVD-RAM 130 by the DVD recorder 100 is usually recorded. On the other hand, the spare area 132 is an area in which the data to be recorded at the position of the defect, if exists in the data area 131, is recorded. That is, it is possible to avoid the data missing, by recording the data into the spare area 132, even if the data cannot be recorded properly into the sector in the data area due to the defect on the recording surface.

The DVD recorder 100 constructed in such a way receives the video data, which may be supplied via digital broadcasting, with input device 140 thereof. Once the user operates the operation unit 150 and inputs an instruction to record the video data into the DVD-RAM 130, the main controller 111 controls the disk drive 121 for rewriting the data against the DVD-RAM 130.

The basic procedure of the data rewriting includes: determining the recording position to rewrite the data into the data area 131 on the DVD-RAM 130; then reading the data already recorded at that position to determine whether the data is rewritable or not for example; then recording new data at that position.

Thus, the DVD recorder 100 performs the defect management during this data rewriting.

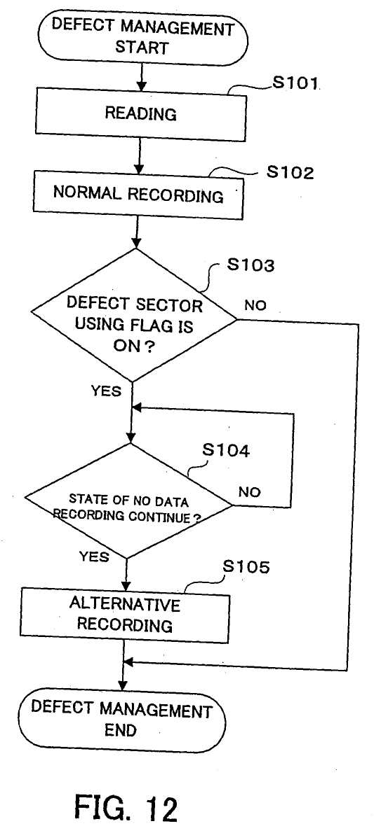

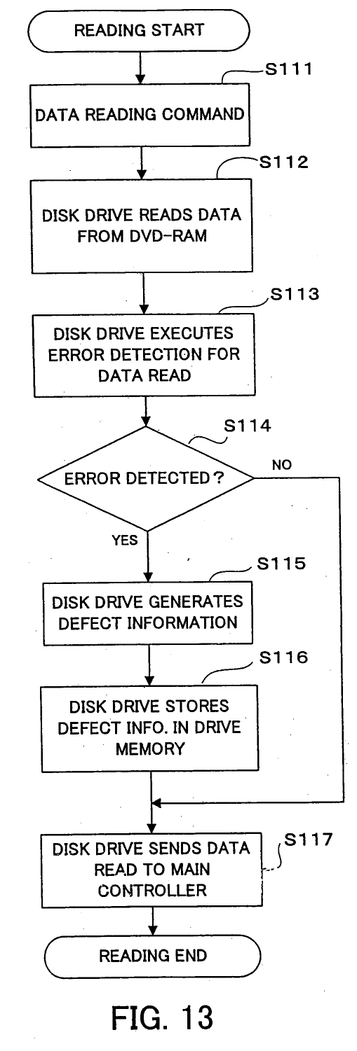

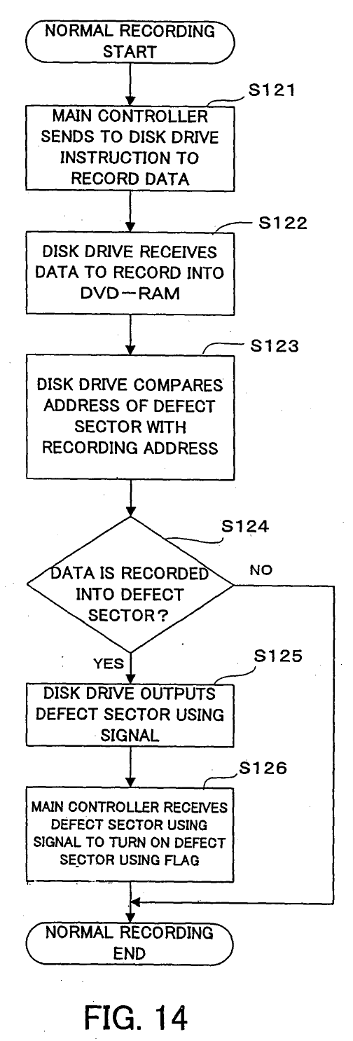

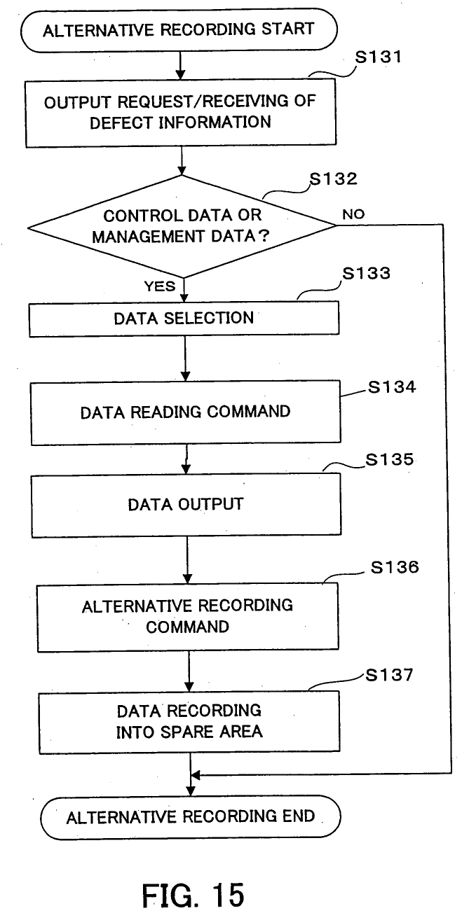

FIG. 12 to FIG. 15 are flow charts respectively illustrating the operation of the defect management by the DVD recorder 100. FIG. 12 shows a main routine of the defect management. FIG. 13 shows a routine of the reading (step S101 in FIG. 12), FIG. 14 shows a routine of the normal recording (step S102 in FIG. 12) and FIG. 15 shows a routine of alternative recording (step S105 in FIG. 12).

In FIG. 12, once the data rewriting against the DVD-RAM 130 starts and simultaneously the defect management starts, the DVD recorder 100 executes the reading (step S101).

Namely, as shown in FIG. 13, the reading is executed by such a manner that, as a first step, the main controller 111 determines the position at which the data is to be rewritten in the data area 131 on the DVD-RAM 130, and locates the head address of that position; and then the main controller 111 sends to the disk drive 121 the head address and the instruction to read, on the basis of the head address, the data recorded in the DVD-RAM 130 (step S111).

Then, the disk drive 121 receives the head address and the instruction sent from the main controller 111 and reads the data from the DVD-RAM 130, on the basis of this head address and this instruction (step S112).

Then, the disk drive 121 performs the error detection against the data read from the DVD-RAM 130 (step S113).

If the error is detected (step S114: YES), it is assumed that the sector on the DVD-RAM 130 in which the data is recorded is in the abnormal condition due to the defect. In this case, the disk drive 121 generates the defect information (step S115). The defect information includes the address of the sector in which the data with defect is recorded (hereinafter this sector is referred to as a “defect sector”), and information indicating the degree of the defect. For instance, the defect sector is in the condition that no more data can be recorded therein, the information indicating the degree of the defect appears as “1”. On the other hand, the defect sector is in the condition that further data can be recorded therein, the information indicating the degree of the defect appears as “0”.

Next, the disk drive 121 stores the defect information into the drive memory 122 (step S116).

Then, the disk drive 121 sends to the main controller 111 the data read from the DVD-RAM 130, and terminates the reading.

On the other hand, when no error is detected against the data read from the DVD-RAM 130 at the steps 114 (step S114: NO), the disk drive 121 immediately sends to the main controller 111 the data read from the DVD-RAM 130, instead of generating and storing the defect information, and terminates the reading.

Now referring again to FIG. 12, once the reading is completed, the DVD recorder 100 then performs the normal recording (step S102).

Namely, as shown in FIG. 14, the main controller 111 sends to the disk drive 121 the head address of the position at which the data is to be rewritten, the instruction to record the data into the DVD-RAM 130 on the basis of the address, and the data to be recorded (step S121).

Next, the disk drive 121 receives from the main controller 111 the address, the instruction of recording and the data to be recorded, and records the received data into the DVD-RAM 130 (step S122).

Then, the disk drive 121 uses the defect information stored in the drive memory 122 to compare the address of the defect sector included in this defect information with the address of the recorded data, i.e. the recording address (step S123). If the data is recorded into the defect sector, the address of the recorded data and the address of the defect data are overlapped, allowing the determination, in comparison between both addresses, whether the data is recorded into the defect sector.

If the address of the recorded data and the address of the defect data are overlapped (or coincide with each other) (step S124: YES), the disk drive 121 sends to the main controller 111 a defect sector using signal to inform the main controller 111 the fact that the data is recorded into the defect sector (step S125). The defect sector using signal is a signal for indicating the fact that the data is recorded into the defect sector.

Then, the main controller 111 receives the defect sector using signal and turns on a defect sector using flag to memorize this flag-condition into the main memory 112 (step S126), and terminates the normal recording. The defect sector using flag is a flag for indicating the fact that the data is recorded into the defect sector.

On the other hand, if the address of the recorded data and the address of the defect data are not overlapped (step S124: NO), the normal recording is immediately terminated.

Referring again to FIG. 12, once the normal recording is terminated, then the main controller 111 checks whether the defect sector using flag recorded in the main memory 112 is turned on or not. In the normal recording, if the data is recorded into the defect sector, the defect sector using flag is turned on. If the defect sector using flag is turned on, the alternative recording is desired to record the data including the same contents of those of the data recorded into the defect sector into the spare area 132 on the DVD-RAM 130.

If the defect sector using flag is turned on (step S103: YES), then the main controller 111 determines whether the present time is within the time period that continuation of the state that the data recording into the data area 131 on the DVD-RAM 130 is not performed is predicted. For instance, if the user inputs the instruction to stop or suspend the data recording via the operation unit 150, the main controller 111 determines that the time point of inputting the instruction is within the time period that continuation of the state that the data recording into the data area 131 on the DVD-RAM 130 is not performed is predicted. Alternatively, if the normal recording of the video or audio data is completed, the main controller 111 may determine that the time point of the completion is within the time period that continuation of the state that the data recording into the data area 131 on the DVD-RAM 130 is not performed is predicted.

If the present time is not within the time period that continuation of the state that the data recording into the data area 131 on the DVD-RAM 130 is not performed is predicted (step S104: NO), the main controller 111 waits for entering that time period. Once the present time enters the time period that continuation of the state that the data recording into the data area 131 on the DVD-RAM 130 is not, performed is predicted (step S104: YES), the DVD recorder 100 performs the alternative recording (step S105).

Namely, as shown in FIG. 15, the main controller 111 requests the disk drive 121 to output the defect information first. The disk drive 121 reads the defect information stored in the drive memory 122 in response to this request and sends it to the main controller 111. The main controller 111 receives the defect information (step S131).

Next, the main controller 111 determines, on the basis of the defect information, the kind of the data in the defect sector on the DVD-RAM 130 recorded in the normal recording. That is, the main controller 111 recognizes information relating to the structure of the data, which is inputted via the input device 140 and recorded into the DVD-RAM 130 in the normal recording (e.g. each address of the picture data, management data or control data included in the video data), and information indicating the address in the data area on the DVD-RAM 130 to which the data is recorded (e.g. the address of the head sector including the position in the DVD-RAM 130 at which the data is rewritten), at least when the normal recording is terminated, and stores those information into the main memory 112. Therefore, the main controller 111 reads these kinds of information from the main memory 112 and recognizes the kind of the data recorded in the defect sector in the normal recording, in comparison of these kinds of information with the address of the defect sector included in the defect information.

Then, if the data recorded in the defect sector is the control or management data (step S132: YES), the main controller 111 determines that the data is the data to be recorded into the spare area (step S133), and performs the alternative recording in the steps S134 to S137. On the other hand, if the data recorded in the defect sector is not the control or management data, such as the picture data (step S132: NO), the data is not determined as the data to be recorded into the spare area and the alternative recording at the steps S134 to S137 is not performed.

If the data recorded in the defect sector is the control or management data and the data is determined as the data to be recorded into the spare area, the main controller 111 sends to the disk drive 121 the address of the defect sector in which the data to be recorded into the spare area 131 is recorded and the instruction to read the data to be recorded into the spare area 131 from the. DVD-RAM 130 (step S134).

The disk drive 121 receives the address and the instruction sent from the main controller 111 and reads the data recorded in the defect sector indicated by the address from the data area 131 on the DVD-RAM 130. Then, the data is sent to the main controller 111 (step S135).

The main controller 111 receives the data sent from the disk drive 121. Then, the main controller 111 sends to the disk drive 121 the received data with the instruction for the alternative recording (step S136).

The disk drive 121 records the data sent from the main controller 111 into the spare area 131 on the DVD-RAM 130, according to the instruction for the alternative recording from the main controller 111 (step S137), and terminates the alternative recording.

Thus, the data rewriting and the defect management in the DVD recorder 100 are terminated. At the step S103 in FIG. 12, if the defect sector using flag is off, it means that the data is not recorded in the defect sector in the normal recording. Therefore, in this case, the defect management is immediately terminated.

According to the first example set forth above, the reading/recording of the data from/into the data area on the DVD-RAM 130 is first executed, and then the alternative recording is executed within a time period that continuation of the state that the data recording into the data area 131 on the DVD-RAM 130 is not performed is predicted, resulting in the temporally continuous recording of the data into the data area 131 on the DVD-RAM 130. Therefore, the data involving the continuous recording or the real time recording such as video or audio data supplied via digital broadcasting can be recorded in a temporally continuous manner into the DVD-RAM 130. Further, since the alternative recording is executed within a time period that continuation of the state that the data recording into the data area 131 on the DVD-RAM 130 is not performed is predicted, the data missing or dropout due to the defect on the DVD-RAM 130 can be avoided.

Additionally, in the alternative recording, since the data recorded into the defect sector on the DVD-RAM 130 is read and recorded into the spare area 132, the data including the same contents of those of the data recorded into the defect sector on the DVD-RAM 130 can be obtained easily and effectively. Therefore, the data to be recorded into the spare area 132 is not necessary to be stored in the buffer memory or the like during the normal recording. This also brings an effect that the buffer memory is not necessary to be employed, even in the case that the temporary data or the great volume of data, such as video data, which may be supplied via digital broadcasting, is the data to be recorded into the DVD-RAM 130.

Further, since the kind of the data to be recorded into the spare area is recognized and only the control or management data is selected as the data to be recorded into the spare area, the data impermissible of dropout or missing such as the control or management data can be securely recorded into the DVD-RAM 130, while the data required for the continuous recording such as video or audio data can be recorded into the data area 131 on the DVD-RAM 130 continuously (both temporally and spatially). Thereby, the failure to reproduce the data due to the absence of the control or management data can be avoided, while the video or audio data recorded in the DVD-RAM 130 can be reproduced continuously.

### Second Example

The second example of the present invention will now be discussed.

The DVD recorder according to the second example is the same as the DVD recorder 100 according to the first example (see FIG. 10) in the basic structure of the hardware. However, the structure (an architecture of the software) and the operation of the defect management according to the second example performed by the hardware are different from those of the first example. Therefore, the structure and the operation of the defect management according to the second example will be discussed below.

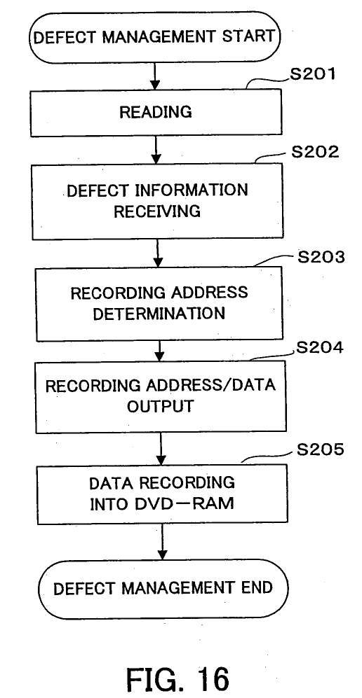

FIG. 16 is a flow chart illustrating the structure and the operation of the defect management performed in the DVD recorder according to the second example. Once the data rewriting into the DVD-RAM 130 is started by the DVD recorder, the defect management is performed during the rewriting.

In FIG. 16, first, the DVD recorder executes the reading (step S201). The detail of the reading is the same as that of the first example (see FIG. 13).

Next, the main controller in the DVD recorder requests the disk drive to output the defect information. The disk drive reads the defect information stored in the drive memory in response to the request and sends it to the main controller. The main controller receives the defect information (step S202).

Then, the main controller determines the recording address of the data on the DVD-RAM, on the basis of the defect information (step S203). Specifically, by comparison of the structure of the data to be recorded into the DVD-RAM with the address of the defect sector, the kind of the data estimated to be recorded into the defect sector is recognized. If the data is the control or management data, the recording address of the data is arranged such that the recording position of the data is located in the normal sector next to the defect sector. On the other hand, if the data estimated to be recorded into the defect sector is not the control or management data, but the data such as video data, the recording address is arranged such that the recording position of the data is located on the defect sector. Additionally, even if the data estimated to be recorded into the defect sector is video data, the recording address may be arranged such that the recording position of the data is located in the normal sector next to the defect sector.

Once the recording position of the data in the DVD-RAM is determined, the main controller sends to the disk drive the recording address and the data to be recorded in the DVD-RAM (step S204).

Then, the disk drive receives the recording address and the data sent from the main controller and records the data in the DVD-RAM, according to the recording address (step S205). Thus, the data rewriting and the defect management are completed.

Thus, according to the second example, since the defect sector of the DVD-RAM is recognized and the recording address of the data is determined to avoid the defect sector before the data recording is started, the data can be just recorded according to the already determined recording address of the data after the data recording is actually started. Therefore, the data can be recorded into the DVD-RAM in a temporally continuous manner. Moreover, since the data can be recorded avoiding the defect sector of the DVD-RAM, the data missing or dropout due to the defect of the recording medium can be avoided. Furthermore, the data recording into the spare area on the DVD-RAM can be avoided, resulting in the spatially continuous recording of the data.

### Third Example

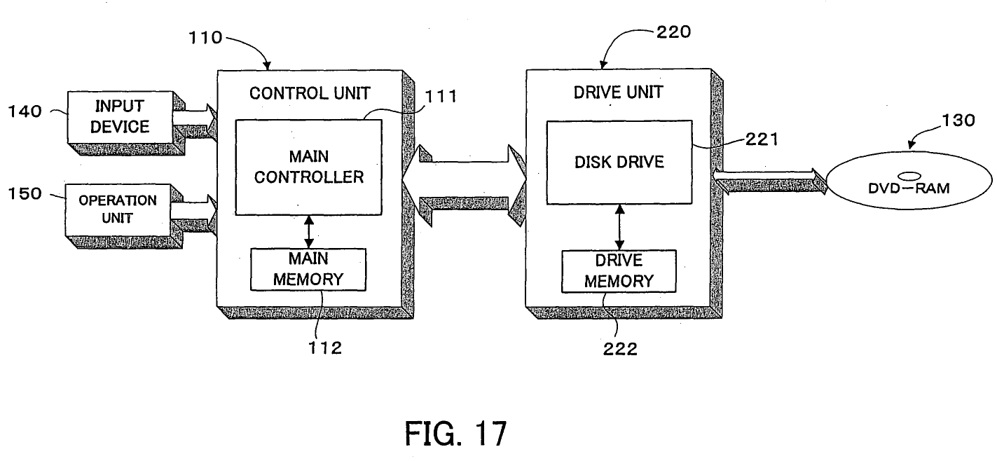

The third example of the present invention will now be discussed, referring to FIG. 17 to FIG. 19.

FIG. 17 is a block diagram illustrating the structure of the DVD recorder according to the third example. The DVD recorder according to the third example is the same as the DVD recorder 100 according to the first example (see FIG. 10) in the basic structure of the hardware except for the disk drive. Therefore, the same components as those of the DVD recorder 100 according to the first example are designated by the same numbers as those of the first example also in the DVD recorder 200 according to the third example as shown in FIG. 17, which components are not further discussed.

A drive unit 220 in the DVD recorder 200 according to the third example includes a disk drive 221 and a drive memory 222. The disk drive 221 is connected to a main controller 111 and has a disk mount, a spindle motor, a spindle servo mechanism, an optical pickup, a tracking servo/focus servo mechanism for controlling the optical pickup and a processing circuit such as a CPU. The drive memory 222 is constructed similar to the drive memory 122 of the first example.

Additionally, the disk drive 221 according to the third example serves a function for the following operation, owing to the self-control in the disk drive 221 independent of the main controller 111.

Namely, when the disk drive 221 records the data into the DVD-RAM 130, it records the data into the data area 131 on the DVD-RAM 130 first; then reads the just recorded data; then determines whether the data is properly recorded; and, if the data is not properly recorded, records the data including the same contents of those of the just recorded data into the spare area 132 (hereinafter this series of operation is referred to as an “automatic alternative recording”). The automatic alternative recording is executed at every time when the data is recorded into one sector or predetermined multiple sectors. Additionally, the automatic alternative recording can be turned off in response to an instruction supplied from an external control device. That is, if the instruction to turn off the automatic alternative recording is externally given to the disk drive 221, the disk drive 221 is not operative to execute the automatic alternative recording during the data recording. On the other hand, if the instruction to turn on the automatic alternative recording is externally given to the disk drive 221, the disk drive 221 is operative to execute the automatic alternative recording during the data recording.

The DVD recorder 200 constructed as mentioned above receives data such as video data, which may be supplied via digital broadcasting, with an input device 140 thereof. Once the user operates the operation unit 150 and inputs the instruction to record the video data into the DVD-RAM 130, the main controller 111 controls the disk drive 221 for the data rewriting against the DVD-RAM 130. The DVD recorder 200 then performs the defect management during the data rewriting.

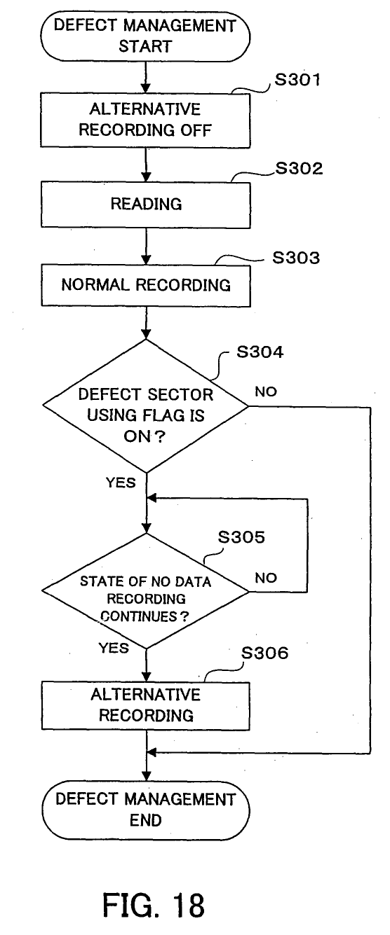

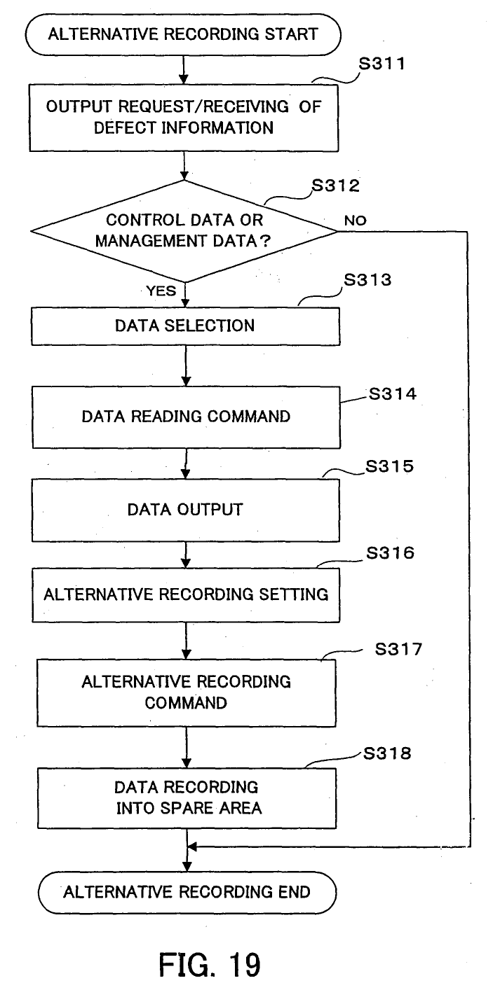

FIG. 18 and FIG. 19 are flow charts respectively illustrating the operation of the defect management by the DVD recorder 200. FIG. 18 shows a main routine of the defect management. FIG. 19 shows a routine of the alternative recording (step S306 in FIG. 18).

In FIG. 18, once the data rewriting is started simultaneously with the beginning of the defect management, the main controller 111 sends to the disk drive 221 the instruction to turn off the automatic alternative recording. Thereby, the automatic alternative recording in the disk drive is turned off (step S301).

Next, the DVD recorder 200 executes the reading, the normal recording, the detection of the defect sector using flag, and the detection the time period that continuation of the state that the data recording into the DVD-RAM 130 is not performed is predicted (steps S302 to S305 in FIG. 18), which operations are the same as the defect management according to the first example (steps S101 to S104 in FIG. 12).

Then, at the step S305 in FIG. 18, if the present time is within the time period that continuation of the state that recording the data into the rewritable recording medium is not performed is predicted (step S305: YES), the DVD recorder 200 executes the alternative recording (step S306). That is, as shown in FIG. 19, the main controller 111 requests the disk drive 221 to output the defect information first. The disk drive 221 reads the defect information stored in the drive memory 222 in response to this request and sends it to the main controller 111. The main controller 111 receives the defect information (step S311).

Then, the main controller 111 detects the kind of the data recorded at the defect sector on the DVD-RAM 130, on the basis of the defect information. If the data recorded at the defect sector is the control or management data (step S312: YES), the main controller 111 determines that the data is data to be recorded into the spare area (step S313) and executes the alternative recording at the steps S314 to S318. On the other hand, if the data recorded in the defect sector is not the control or management data, but data such as video data (step S312: NO), the data is not determined as the data to be recorded into the spare area and the alternative recording is not executed.

Then, the main controller 111 sends to the disk drive 221 the address of the defect sector in which the data to be recorded into the spare area 131 is recorded and the instruction to read the data to be recorded into the spare area 131 from the DVD-RAM 130 (step S314).

The disk drive 221 receives the address and the instruction sent from the main controller 111 and reads the data recorded in the defect sector indicated by the address from the DVD-RAM 130. Then, the data is sent to the main controller 111 (step S315). Thus, the main controller 111 receives the data.

Next, the main controller 111 sends to the disk drive 221 the instruction to set the automatic alternative recording. In response to this instruction, the disk drive 221 set the automatic alternative recording on (step S316).

Then, the main controller 111 sends to the disk drive 221 the received data with the instruction of recording (step S317).

The disk drive 221 records the data sent from the main controller 111 into the DVD-RAM 130, according to the instruction of recording from the main controller 111. At this time, since the disk drive 221 executes the automatic alternative recording, the data sent from the main controller 111 is recorded into the spare area 131 on the DVD-RAM 130 (step S318).

Thus, the data rewriting and the defect management in the DVD recorder 200 are completed.

According to the third example set forth above, similar to the first example, the data recording into the DVD-RAM 130 can be executed in a temporally continuous manner and thereby the data involving the continuous recording or the real time recording, such as video or audio data supplied via digital broadcasting, can be recorded into the DVD-RAM 130 in a temporally continuous manner. On the other hand, since the alternative recording is executed within the time period that continuation of the state that the data recording into the data area 131 on the DVD-RAM 130 is not performed is predicted, the data missing or dropout due to the defect of the DVD-RAM 130 can be avoided.

Particularly, the disk drive having the function of the automatic alternative recording improves the design efficiency owing to this function and thereby provides more easily the defect management apparatus according to the present invention.

It is noted that the present invention is not limited to the examples set forth above. In examples set forth above, the generating of the defect information or the error detection for the data read from the DVD-RAM is executed within the drive unit, however, the drive unit may serve only a function of reading/recording of the data from/into the DVD-RAM, while the main controller may serve a function of executing the data processing such as the generating of the defect information or the error detection from the read data, alternatively a special designed data processing device may serve the function.

In examples set forth above, the alternative recording is executed only for the control or management data, however, the alternative recording may be executed for other kinds of data undesirable of dropout or missing, particularly important data impermissible of dropout or missing, besides the control or management data.

In examples set forth above, the defect information is stored and maintained in the drive memory 122 (222), the defect information may be stored and maintained in the free space in the DVD-RAM 130.

In the first and second examples set forth above, the present invention is exemplified in the DVD recorder for recording against DVD-RAMs, however, the present invention may be applied to the DVD recorder or the drive apparatus for recording against DVD-RWs or other rewritable DVDs. Even in the case of an apparatus or unit not having the defect management function therewith, such as an existing drive unit for DVD-RWs, the defect management can be performed by applying the present invention to the existing unit or apparatus.

In examples set forth above, the DVD recorder is exemplified, however, the present invention is applicable to a recorder for magneto-optical disks such as MO disks, phase change disks, optical cards or other rewritable recording media.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2002-185879 filed on Jun. 26, 2002 including the specification, claims, drawings and summary is incorporated herein by reference in its entirety.

What is claimed is:

1. A defect management apparatus for performing a defect management for a rewritable recording medium having a data area and a spare area in its recording surface, the defect management apparatus comprising:
a defect information generating device for generating defect information which indicates at least a position of a defect existing on or in the recording surface of the rewritable recording medium, when data recorded in the recording surface of the rewritable recording medium is read;
a recording position determining device for determining, on the basis of the defect information, whether or not the data is recorded at the position of the defect, when the data is recorded into the rewritable recording medium;
an alternative recording device for executing an alternative recording for recording data including the same contents as those of the data recorded at the position of the defect into the spare area of the rewritable recording medium, if the recording position determining device determines that the data is recorded at the position of the defect; and
a time controlling device for controlling a time point to execute the alternative recording by the alternative recording device such that the alternative recording is executed within a time period that continuation of a state that recording the data into the rewritable recording medium is not performed is predicted.

2. The defect management apparatus according to claim 1, wherein the alternative recording device comprises:
a recognizing device for recognizing the position of the defect on the basis of the defect information;
a reading device for reading the data recorded at the position of the defect recognized by the recognizing device; and
a recording device for recording the data read by the reading device into the spare area of the rewritable recording medium.

3. The defect management apparatus according to claim 1, wherein the alternative recording device comprises:
a recognizing device for recognizing the position of the defect on the basis of the defect information;
an alternative-recording determining device for determining whether or not the data recorded at the position of the defect is data that requires the alternative recording;
a reading device for reading the data recorded at the position of the defect recognized by the recognizing device, if the alternative-recording determining device determines that the data recorded at the position of the defect is the data that requires the alternative recording; and
a recording device for recording the data read by the reading device into the spare area of the rewritable recording medium.

4. The defect management apparatus according to claim 3, wherein the alternative-recording determining device determines that the data recorded at the position of the defect is the data that requires the alternative recording, if the data recorded at the position of the defect is control data or management data.

5. The defect management apparatus according to claim 1, wherein the time controlling device allows the alternative recording device to execute the alternative recording at a time point that an instruction to stop or suspend the data recording is inputted.

6. The defect management apparatus according to claim 1, wherein the time controlling device allows the alternative recording device to execute the alternative recording at a time point that the recording of video or audio data to be recorded continuously is complete.

7. A data recording apparatus for recording data into a rewritable recording medium having a data area and a spare area in its recording surface while performing a data communication with a recording control apparatus, the data recording apparatus comprising:
a defect information generating device for generating defect information which indicates at least a position of a defect existing on or in the recording surface of the rewritable recording medium, when the data recorded in the recording surface of the rewritable recording medium is read;
a recording position determining device for determining, on the basis of the defect information, whether or not the data is recorded at the position of the defect, when the data is recorded into the rewritable recording medium;
a sending device for sending notice that the data is recorded at the position of the defect to the recording control apparatus, if the recording position determining device determines that the data is recorded at the position of the defect; and
an alternative recording device for executing an alternative recording for recording data including the same contents as those of the data recorded at the position of the defect into the spare area of the rewritable recording medium, if an instruction to execute the alternative recording is received from the recording control apparatus.

8. The data recording apparatus according to claim 7, wherein the alternative recording device comprises:
a reading device for reading the data recorded at the position of the defect from the rewritable recording medium; and
a recording device for recording the data read by the reading device into the spare area of the rewritable recording medium.

9. A recording control apparatus for controlling a data recording apparatus for recording data into a rewritable recording medium having a data area and a spare area in its recording surface, while performing a data communication with the data recording apparatus, the recording control apparatus comprising:
a recognizing device for recognizing that the data recording apparatus records the data at a position of a defect existing on or in a recording surface of the rewritable recording medium;
an instructing device for sending, to the data recording apparatus, an instruction to execute an alternative recording for recording data including the same contents as those of the data recorded at the position of the defect into the spare area of the rewritable recording medium, if the recognizing device recognizes that the data recording apparatus records the data at the position of the defect; and
a time controlling device for controlling a time point to send the instruction to execute the alternative recording via the instructing device such that the instruction is sent within a time period that continuation of a state that recording the data into the rewritable recording medium is not performed is predicted.

10. The recording control apparatus according to claim 9, wherein the instructing device comprises an alternative-recording determining device for determining whether or not the data recorded at the position of the defect by the data recording apparatus is data that requires the alternative recording.

11. The recording control apparatus according to claim 10, wherein the alternative-recording determining device determines that the data recorded at the position of the defect is the data that requires the alternative recording, if the data recorded at the position of the defect is control data or management data.

12. The recording control apparatus according to claim 9, wherein the time controlling device allows the instructing device to send the instruction to execute the alternative recording at a time point that an instruction to stop or suspend the data recording is inputted.

13. The recording control apparatus according to claim 9, wherein the time controlling device allows the instructing device to send the instruction to execute the alternative recording at a time point that the recording of video or audio data to be recorded continuously is complete.

14. A defect management apparatus for performing a defect management for a rewritable recording medium, the defect management apparatus comprising:
a defect information generating device for generating defect information which indicates at least a position of a defect existing on or in a recording surface of the rewritable recording medium, when data recorded in the recording surface of the rewritable recording medium is read;
a recording position determining device for determining, on the basis of the defect information, a recording position which is located at a position different from the position of the defect; and
a recording device for recording the data at the recording position determined by the recording position determining device.

15. The defect management apparatus according to claim 14, wherein the recording position determining device determines the recording position different from the position of the defect, if the data to be recorded is control data or management data.

16. A computer program product in a computer-readable medium for tangibly embodying a program of instructions executable by a computer to make the computer function as a defect management apparatus for performing a defect management for a rewritable recording medium having a data area and a spare area in its recording surface, the defect management apparatus comprising:
a defect information generating device for generating defect information which indicates at least a position of a defect existing on or in the recording surface of the rewritable recording medium, when data recorded in the recording surface of the rewritable recording medium is read;
a recording position determining device for determining, on the basis of the defect information, whether or not the data is recorded at the position of the defect, when the data is recorded into the rewritable recording medium;
an alternative recording device for executing an alternative recording for recording data including the same contents as those of the data recorded at the position of the defect into the spare area of the rewritable recording medium, if the recording position determining device determines that the data is recorded at the position of the defect; and
a time controlling device for controlling a time point to execute the alternative recording by the alternative recording device such that the alternative recording is executed within a time period that continuation of a state that recording the data into the rewritable recording medium is not performed is predicted.

17. A computer program product in a computer-readable medium for tangibly embodying a program of instructions executable by a computer to make the computer function as a data recording apparatus for recording data into a rewritable recording medium having a data area and a spare area in its recording surface while performing a data communication with a recording control apparatus, the data recording apparatus comprising:
a defect information generating device for generating defect information which indicates at least a position of a defect existing on or in the recording surface of the rewritable recording medium, when the data recorded in the recording surface of the rewritable recording medium is read;
a recording position determining device for determining, on the basis of the defect information, whether or not the data is recorded at the position of the defect, when the data is recorded into the rewritable recording medium;
a sending device for sending notice that the data is recorded at the position of the defect to the recording control apparatus, if the recording position determining device determines that the data is recorded at the position of the defect; and
an alternative recording device for executing an alternative recording for recording data including the same contents as those of the data recorded at the position of the defect into the spare area of the rewritable recording medium, if an instruction to execute the alternative recording is received from the recording control apparatus.

18. A computer program product in a computer-readable medium for tangibly embodying a program of instructions executable by a computer to make the computer function as a recording control apparatus for controlling a data recording apparatus for recording data into a rewritable recording medium having a data area and a spare area in its recording surface, while performing a data communication with the data recording apparatus, the recording control apparatus comprising:
a recognizing device for recognizing that the data recording apparatus records the data at a position of a defect existing on or in a recording surface of the rewritable recording medium;
an instructing device for sending, to the data recording apparatus, an instruction to execute an alternative recording for recording data including the same contents as those of the data recorded at the position of the defect into the spare area of the rewritable recording medium, if the recognizing device recognizes that the data recording apparatus records the data at the position of the defect; and
a time controlling device for controlling a time point to send the instruction to execute the alternative recording via the instructing device such that the instruction is sent within a time period that continuation of a state that recording the data into the rewritable recording medium is not performed is predicted.

19. A computer program product in a computer-readable medium for tangibly embodying a program of instructions executable by a computer to make the computer function as a defect management apparatus for performing a defect management for a rewritable recording medium, the defect management apparatus comprising:
a defect information generating device for generating defect information which indicates at least a position of a defect existing on or in a recording surface of the rewritable recording medium, when data recorded in the recording surface of the rewritable recording medium is read;
a recording position determining device for determining, on the basis of the defect information, a recording position which is located at a position different from the position of the defect; and
a recording device for recording the data at the recording position determined by the recording position determining device.
